(19) United States
(12) Patent Application Publication
(10) Pub. No.: US 2022/0151167 A1
(43) Pub. Date: May 19, 2022

(54) TREE FELLING BLADE FOR USE WITH HEAVY EQUIPMENT

(71) Applicant: 106 Reforestation, LLC, Sandy, UT (US)

(72) Inventor: Michael A. Siaperas, Sandy, UT (US)

(73) Assignee: 106 Reforestation, LLC, Sandy, UT (US)

(21) Appl. No.: 17/522,291

(22) Filed: Nov. 9, 2021

Related U.S. Application Data
(60) Provisional application No. 63/113,728, filed on Nov. 13, 2020.

(51) Int. Cl. A01G 23/089; E02F 3/96

(52) U.S. Cl. CPC A01G 23/089; E02F 3/962

(57) ABSTRACT

Systems and devices for use in executing a tree felling operation are disclosed. A tree felling blade for use in connection with a tree felling operation includes a leading cutter comprising a leading cutter point and a leading transverse cutting blade. The tree felling blade includes a trailing cutter comprising a trailing cutter point and a trailing transverse cutting blade. The tree felling blade comprises a roller portion comprising a concave curvature, wherein the roller portion is connected to the leading cutter and the trailing cutter.

### TECHNICAL FIELD

The disclosure relates to systems and devices relating to heavy equipment and particularly relates to a heavy equipment blade.

### BACKGROUND

Heavy equipment and heavy machinery can be exceptionally dangerous to operate. Heavy equipment by its nature is large, heavy, and capable of causing injury to people or animals and causing damage to property. One implementation where heavy equipment is particularly dangerous is tree felling operations. Tree felling operations may be executed to cut down and remove trees and other plant life to promote the wellbeing of an ecosystem, to curtail the spread of wildfires, and for other reasons. Because tree felling operations include cutting down and hauling away mature trees that can be heavy, large, and dangerous to heavy equipment operators, tree felling is inherently a dangerous task. Therefore, there is a desire to develop systems, methods, and devices that increase the safety and efficiency of tree felling operations and reduce the likelihood that accidents will occur when operating heavy equipment.

In light of the foregoing, disclosed herein are systems, methods, and devices for improved tree felling blades for use in connection with a tree felling operation.

### BRIEF DESCRIPTION OF THE DRAWINGS

Non-limiting and non-exhaustive implementations of the disclosure are described with reference to the following figures, wherein like reference numerals refer to like or similar parts throughout the various views unless otherwise specified. Advantages of the disclosure will become better understood with regard to the following description and accompanying drawings where:

FIG. 1 is a front isometric view of tree felling equipment comprising a dozer and a tree felling blade;

FIG. 2 is a rear isometric view of tree felling equipment comprising a dozer and a tree felling blade;

FIG. 3 is a side view of tree felling equipment comprising a dozer and a tree felling blade;

FIG. 4 is an aerial top-down view of tree felling equipment comprising a dozer and a tree felling blade;

FIG. 5 is a front view of tree felling equipment comprising a dozer and a tree felling blade;

FIG. 6 is a rear view of tree felling equipment comprising a dozer and a tree felling blade;

FIG. 7 is a rear isometric view of a tree felling blade;

FIG. 8 is an underside view of a tree felling blade;

FIG. 9 is a front isometric view of a tree felling blade;

FIG. 10 is a side view of a tree felling blade;

FIG. 11 is a side view of a tree felling blade;

FIG. 12 is a rear isometric interior view of a tree felling blade;

FIG. 13 is a cross-sectional view of a tree felling blade;

FIG. 14 is an aerial top-down view of a tree felling blade;

FIG. 15 is a schematic diagram illustrating exemplary components of a system for inter-machine communication;

FIG. 16 illustrates an exemplary setup for a tree felling operation;

FIG. 17 illustrates execution of a first phase of an exemplary tree felling operation;

FIG. 18 illustrates execution of a second phase of an exemplary tree felling operation;

FIG. 19 illustrates execution of a third phase of an exemplary tree felling operation;

FIG. 20 illustrates execution of a third phase of an exemplary tree felling operation;

FIG. 21 illustrates the space cleared by a successful tree felling operation;

FIG. 22 illustrates an exemplary execution of a tree felling operation; and

FIG. 23 is a schematic flow chart diagram of a method for a tree felling operation.

### DETAILED DESCRIPTION

Disclosed herein are systems, methods, and devices for tree felling operations. Specifically, disclosed herein are improved embodiments of a tree felling blade for use with heavy equipment. The tree felling blade described herein may be used in connection with a heavy equipment dozer for uprooting, knocking down, and/or crushing trees and other plant life during a tree felling operation.

One means for preventing future forest fires and curtailing the spread of an active fire is the method of tree felling. Tree felling is a forestry and logging practice in which most or all trees in an area are uniformly cut down or uprooted. Tree felling is used by foresters to create certain types of forest ecosystems and to promote select species that require an abundance of sunlight or grow in large even-age stands. Tree felling can be used to curtail the spread of a forest fire by creating a gap in the tree growth, and thereby preventing the fire from spreading tree-to-tree.

One method of tree felling includes the use of heavy equipment configured to cut down and uproot trees in its path. This process of tree felling can be exceptionally dangerous for the heavy equipment operator. Trees can repeatedly fall on top of the heavy equipment and endanger the life and safety of the operator. Traditional methods of tree felling present numerous dangers for the tree felling operators, and therefore, it is desirable to develop improved, safer methods of tree felling.

In light of the foregoing, disclosed herein are improved embodiments of tree felling blades for use in connection with heavy equipment during a tree felling operation. The embodiments described herein enable numerous benefits over dozer blades known in the art that are not specialized for tree felling operations or are inefficient at tipping, uprooting, and removing trees and tree root balls during a tree felling operation.

Before the methods, systems, and devices for tree felling blades are disclosed and described, it is to be understood that this disclosure is not limited to the configurations, process steps, and materials disclosed herein as such configurations, process steps, and materials may vary somewhat. It is also to be understood that the terminology employed herein is used for describing implementations only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

A detailed description of systems, methods, and devices consistent with embodiments of the disclosure is provided below. While several embodiments are described, it should be understood that this disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments may be practiced without some or all of these details. Moreover, for clarity, certain technical material that is known in the related art has not been described in detail to avoid unnecessarily obscuring the disclosure.

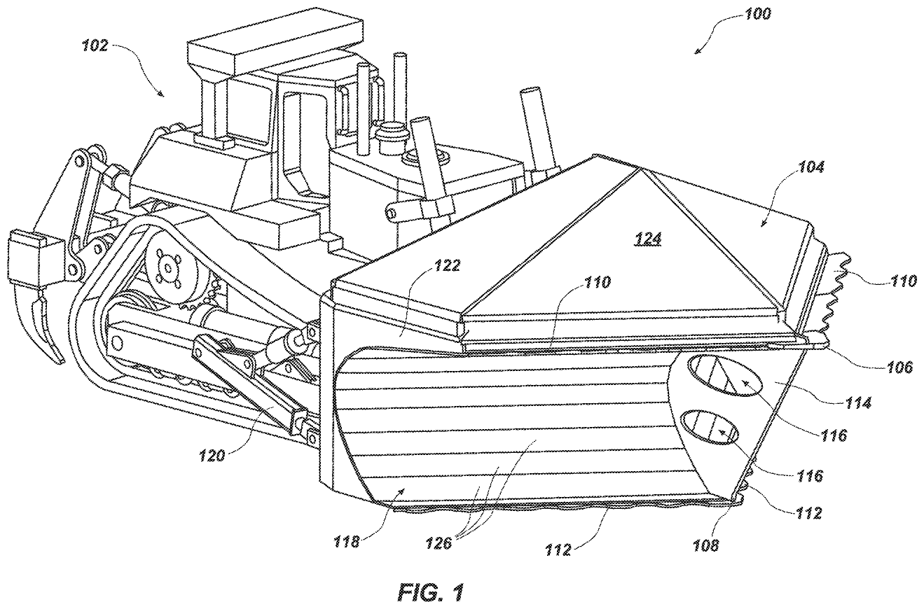

Referring now to the figures, FIG. 1 is an isometric view of tree felling equipment 100. The tree felling equipment 100 includes a dozer 102 with a tree felling blade 104 attached thereon. The tree felling blade 104 may alternatively be referred to as a “shark blade” or a “tip, lift, and roll blade.” The tree felling blade 104 is configured to remove trees and accompanying root balls during a tree felling operation. When the tree felling blade 104 comes in contact with a tree, the tree felling blade 104 first tips the tree over and then lifts the tree and its accompanying root ball out of the ground. The tree felling blade 104 additionally rolls uprooted trees out of the way of the dozer 102 before the dozer 102 comes in contact with the uprooted trees. The tree felling blade 104 represents significant improvements over conventional dozer blades and tree felling blades.

The tree felling blade 104 includes an upper cutter point 106 and a lower cutter point 108. The tree felling blade 104 further includes one or more upper transverse cutting blades 110 and one or more lower transverse cutting blades 112. The tree felling blade 104 includes a leading blade 114 extending from the upper cutter point 106 to the lower cutter point 108. The leading blade 114 may include one or more blade holes 116 extending therethrough. The tree felling blade 104 includes one or more roller portions 118 extending from a center point near the upper cutter point 106 and the lower cutter point 108 to an outer edge of the tree felling blade 104. The tree felling blade 104 includes a debris shield 124 comprising a tapered shaped such that trees and other debris fall away from the dozer 102 and out of the pathway of the dozer 102. The tree felling blade 104 may be attached to the dozer 102 with one or more couplers 120 configured for releasably securing the tree felling blade 104 to the dozer 102.

In the embodiment illustrated in FIG. 1, the upper cutter point 106 and the upper transverse cutting blades 110 make up the forward-most edge of the tree felling blade 104 and therefore constitute the leading cutter of the tree felling blade 104. The lower cutter point 108 and the lower transverse cutting blades 112 are disposed behind the upper cutter point 106 and the upper transverse cutting blades 110 and therefore constitute the trailing cutter of the tree felling blade 104. In an alternative embodiment (not illustrated in FIG. 1), the lower cutter point 108 and the lower transverse cutting blades 112 are the forward-most point of the tree felling blade 104 and serve as the leading cutter. In this embodiment, the upper cutter point 106 and the upper transverse cutting blade 110 serve as a trailing cutter.

As discussed herein, the leading cutter comprises a leading cutter point and one or more leading transverse cutting blades. The leading cutter is the forward-most cutter on the tree felling blade 104, whether the leading cutter is located at the top or bottom of the tree felling blade 104. Further as discussed herein, the trailing cutter comprises a trailing cutter point and one or more trailing transverse cutting blades. The trailing cutter is located behind the leading cutter, relative to the front-facing portion of the dozer 102.

The leading cutter of the tree felling blade 104 is configured to tip over a tree while gripping the tree with enough force to lift the tree's root ball out of the ground as the tree tips over. The trailing cutter of the tree felling blade 104 is configured to assist in lifting roots out of the ground as the dozer 102 drives forward during a tree felling operation.

The upper cutter point 106 is positioned at or near the midpoint of a front side of the tree felling blade 104. The upper cutter point 106 may be the forward-most point of the tree felling blade 106 such that the upper cutter point 106 is the first portion of the tree felling blade 104 to come in contact with a tree or other obstruction during a tree felling operation. The upper cutter point 106 may include a blade or a serrated edge configured for digging into the side of a tree and assisting in uprooting the tree. The upper cutter point 106 may have a scalloped edge to assist in gripping the side of a tree such that the tree can be lifted out of the ground with the root ball intact.

The lower cutter point 108 is position at or near the midpoint of a front side of the tree felling blade 104. The lower cutter point 108 may be the forward-most point of the tree felling blade 106 on the bottom edge of the tree felling blade 106, while being positioned back relative to the upper cutter point 106. The lower cutter point 108 may be located a certain distance above the ground during operation. In various embodiments, the lower cutter point 108 may be located from one-inch above the ground to about 18-inches above the ground. Similar to the upper cutter point 106, the lower cutter point 108 may include a blade, serrated edger, or scalloped edge to assist in gripping the side of a tree.

The upper transverse cutting blades 110 extend from the upper cutter point 106 on one end and to a side portion 122 of the tree felling blade 104 on the other end. The tree felling blade 104 may include two upper transverse cutting blades 110, wherein a first upper transverse cutting blade 110 extends from the upper cutter point 106 to a first side of the tree felling blade 104, and a second upper transverse cutting blade extends from the upper cutter point 106 to a second, opposite side of the tree felling blade 104. The two upper transverse cutting blades 110 may mirror one another and have equivalent dimensions. The upper transverse cutting blades 110 may have a serrated or scalloped edge. The serrated or scalloped edge assists in gripping the sides of trees such that the tree can be tipped and uprooted during the tree felling operation. The upper transverse cutting blades 110 may form the forward-most portion of the tree felling blade 104 as illustrated in FIG. 1.

The lower transverse cutting blades 112 extend from the lower cutter point 108 on one end to a side portion 122 of the tree felling blade 104 on the other end. The lower transverse cutting blades 112 may alternatively be referred to as a “root bar.” The tree felling blade 104 may include two lower transverse cutting blades 112 that mirror the upper transverse cutting blades 110, located above. The lower transverse cutting blades 112 may have a shorter length relative to the upper transverse cutter blades 110. The lower transverse cutting blades 112 may be the second most forward portion of the tree felling blade 104, second to the upper transverse cutting blades 110 as illustrated in FIG. 1. The lower transverse cutting blades 112 may have a serrated or scalloped edge. The serrated or scalloped edge assists in gripping the sides of trees such that the tree can be tipped and uprooted during the tree felling operation.

The leading blade 114 extends from the upper cutter point 106 on one end to the lower cutter point 108 on the opposite end, as illustrated in FIG. 1. The leading blade 114 may alternatively be referred to as the “central spine.” The leading blade may be attached to the upper cutter point 106 and the lower cutter point 108 and positioned perpendicular or nearly perpendicular to the planes of the upper transverse cutting blades 110 and lower transverse cutting blades 112. The leading blade 114 may have a flat edge, rather than the scalloped or serrated edge deployed on the upper and lower transverse cutting blades 110, 112. In an alternative embodiment, the leading blade 114 also has a serrated or scalloped edge. The leading blade 114 may be located backward relative to the forward-most point of the upper and lower cutter points 106, 108.

The one or more blade holes 116 are disposed within the leading blade 114. The blade holes 116 may have a circular or elliptical shape as illustrated in FIG. 1. The blade holes 116 reduce the mass of the leading blade 114 and therefore reduce the overall weight of the tree felling blade 104. In an alternative embodiment, the tree feeling blade 104 does not include a blade hole 116 and the leading blade 114 is instead a solid piece.

The one or more roller portions 118 of the tree felling blade 104 are configured to push and roll root balls out of the way of the dozer 102 during operation. The roller portions 118 extend from the leading blade 114 at one end to the side portion 122 of the tree felling blade 104 on the other end. The tree felling blade 104 may have two roller portions 118 that mirror one another relative to the plane of the leading blade 114. The roller portions 118 may have a curved surface providing a half-elliptical shape as illustrated in FIG. 1. The roller portions 118 include a plurality of ribbed surfaces 126 making up a concave curved shape. The roller portions 118 assist in lifting and rolling trees and root balls out of the way of the dozer 102 during a tree felling operation.

The couplers 120 releasably secure the tree felling blade 104 to the dozer 102. In an embodiment, one or more of the couplers 120 includes a plug-and-play adaptor to quickly bolt the tree felling blade 104 on to the dozer. The plug-and-play adaptor may specifically be configured for quickly bolting the tree felling blade 104 on to a JD 1050 Dozer.

The side portions 112 of the tree felling blade 104 may include a flat surface comprising a plane running parallel or nearly parallel to the sides of the dozer 102 and the direction of driving by the dozer 102. The upper and lower transverse cutting blades 110, 112 may terminate at the side portions 122. The plane of the side portions 122 may include a curved cutout marking the edge of the curved roller portions 118, as illustrated in FIG. 1.

The debris shield 124 forms the top surface of the tree felling blade 104 and may be considered the rooftop of the tree felling blade 104. The debris shield has a sloped surface to deflect falling debris off to the side and prevent falling debris from falling on to the dozer 102 or obstructing the view of a dozer 102 operator.

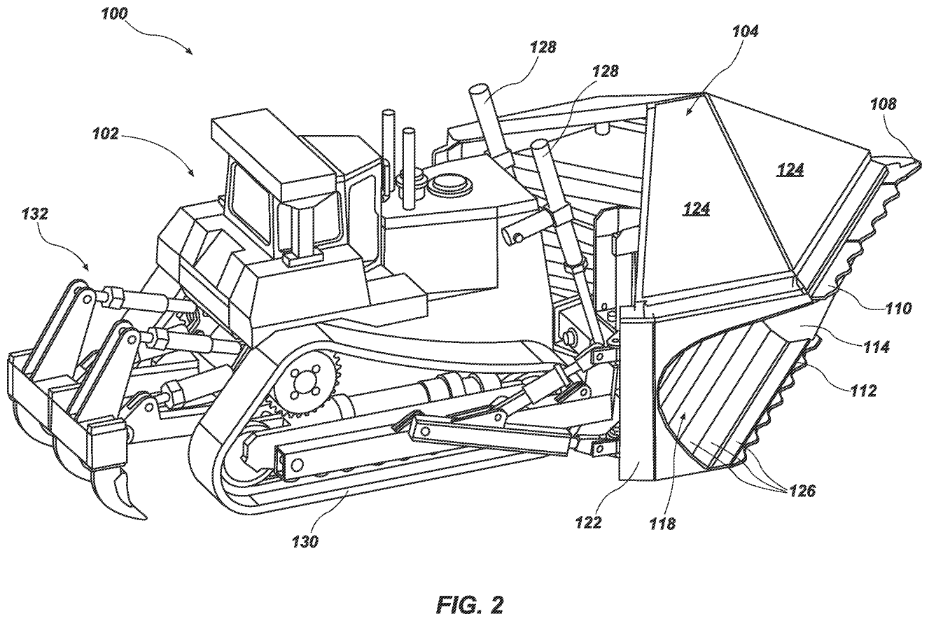

FIG. 2 is an isometric view of the tree felling equipment 100. The tree felling equipment 100 includes a dozer 102 and a tree felling blade attached to the dozer 102. The dozer 102 may further include a digging system 132 including one or more digging blades attached to pistons configured to raise and lower the digging blades during operation. The dozer 102 may alternatively include some other system that may come stock on the dozer or may be particularly beneficial to a tree felling operation. The dozer 102 may include tracks 130 and may alternatively include wheels. The transportation means of the dozer 102 may be particularly suited to the application in which the dozer 102 will be used. The tree felling blade 104 may further be secured to the dozer 102 by way of one or more pistons 128. The pistons 128 may come stock on the dozer 102 for attaching a blade to the dozer 102. In the embodiments described herein, the tree felling blade 104 is attached to the dozer 102 and can be raised and lowered with the pistons 128.

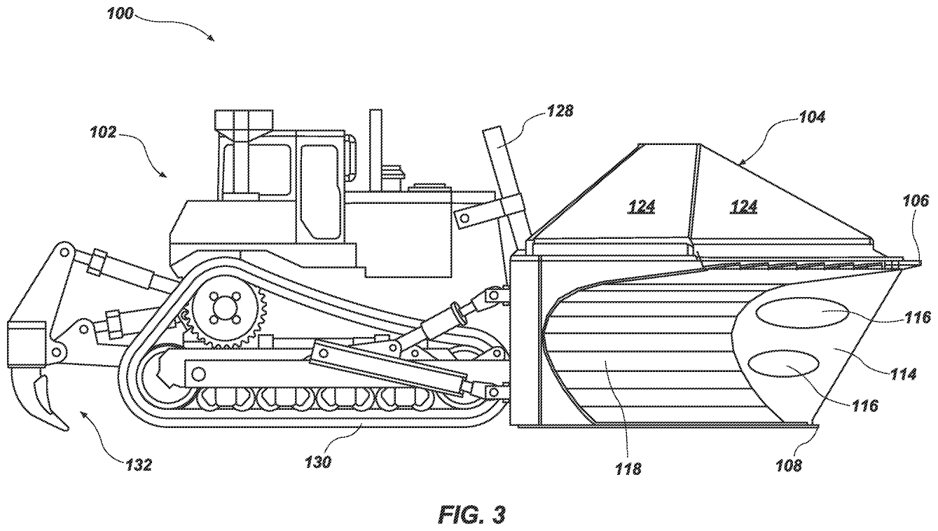

FIG. 3 is a side view of the tree felling equipment 100 comprising the dozer 102 and the tree felling blade 104. In an embodiment, the forward length of the tree felling blade 104, extending from the point where the tree felling blade is attached to the dozer 102 to the upper cutter point 106, is equal or nearly equal to the length of the dozer 102 itself. Further, the vertical height of the tree felling blade 104 may be similar to the height of the dozer 102 itself. The height of the tree felling blade 104 may be configured such that a dozer 102 operator sitting within the cockpit of the dozer 102 can see over the top of the debris shield 124.

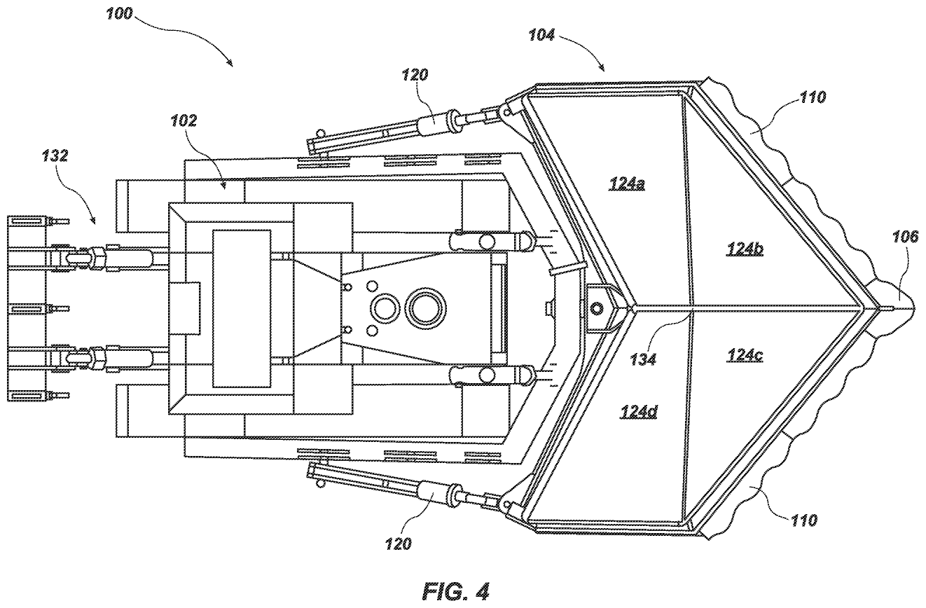

FIG. 4 is an aerial top-down view of the tree felling equipment 100. In the embodiment illustrated in FIG. 4, the debris shield 124 includes four portions having different slopes, 124a, 124b, 124c, and 124d. Each of the four portions of the debris shield 124 slopes down relative to the peak 134 of the debris shield 124. The debris shield portions 124a, 124d may slope down and away from the peak 134 as mirrors of one another. Further, the debris shield portions 124b, 124c may slope down and away from the peak 124 as mirrors of one another. The debris shield 124 may have fewer than four portions or more than four portions having different slopes away from the peak 134. The debris shield 124 is configured to promote trees and other debris to fall away from the dozer 102 and out of the pathway of the dozer 102 during operation. The debris shield 124 effectively deflects debris that might pose a safety hazard to the operator of the dozer 102 or otherwise interrupt the tree felling operation if not properly pushed out of the pathway of the dozer 102.

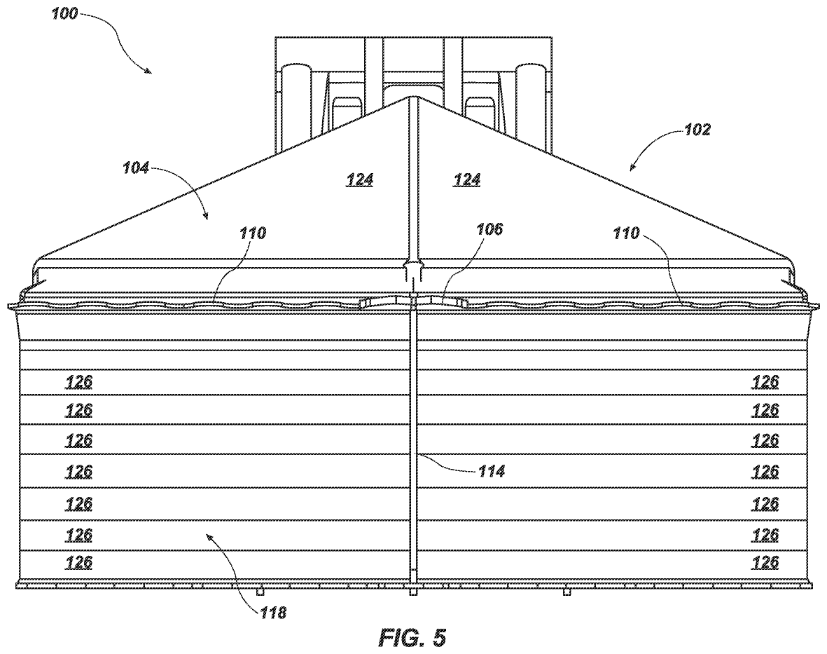

FIG. 5 is a straight-on view of the front of the tree felling equipment 100. The roller portions 118 include a plurality of ribbed surfaces 126. Each of the plurality of ribbed surfaces 126 may be flat or nearly flat, and the plurality of ribbed surfaces 126 may collectively form a concave shape for the roller portions 118. In an alternative embodiment, one or more of the plurality of ribbed surfaces 126 has a curved shape, and the plurality of ribbed surfaces 126 form a smooth concave shape. The collection of ribbed surfaces 126 form a curved, concave shape that pushes and rolls dirt-covered root balls out of the way of the trailing dozer 102 during operation. The roller portion 118 is effective at rolling away trees, root balls, and other debris when executing a tree felling operation.

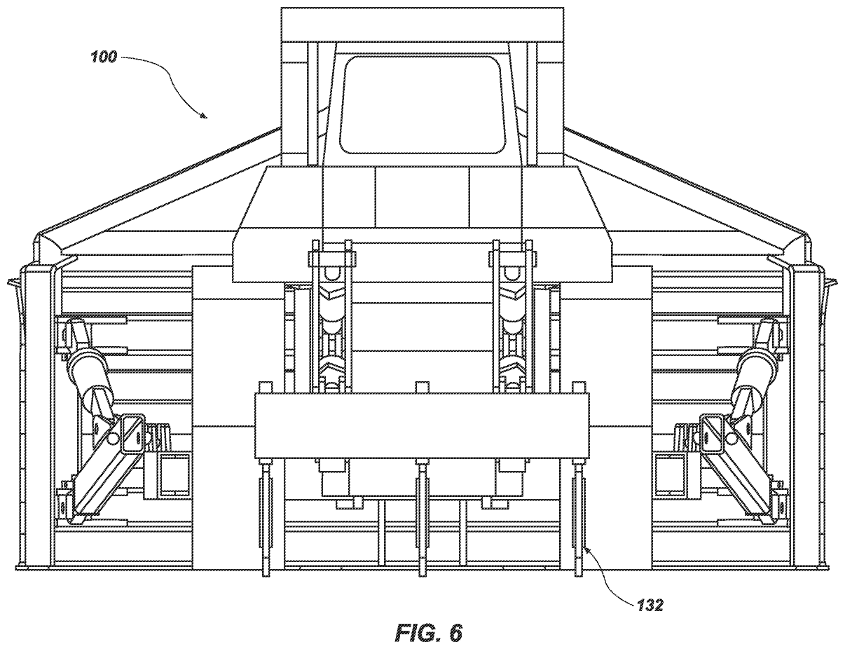

FIG. 6 is a straight-on view of the rear of the tree felling equipment 100. The view in FIG. 6 illustrates the rear-side of the dozer 102 cockpit along with the digging system 132.

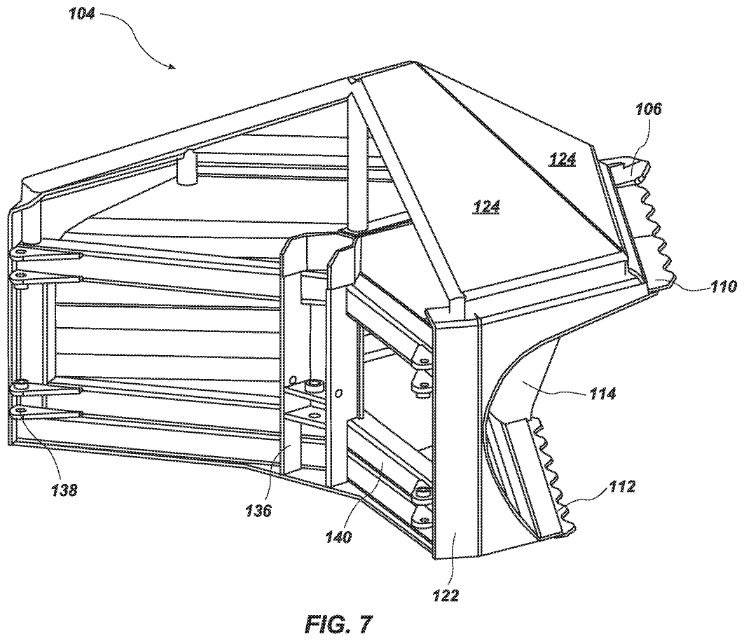

FIG. 7 is an isometric rear view of a tree felling blade 104. The view in FIG. 7 illustrates a rear side of the tree felling blade 104, where the tree felling blade 104 is attached to a dozer 102. The cross-bars 140 and vertical supports 136 provide structural support to the tree felling blade 104 without significantly increasing the weight of the tree felling blade 104. The tree felling blade 104 may include a plurality of pin holes 138 for receiving a fastener pin. The fastener pin attaches the tree felling blade 104 to the dozer 102 through the pin hole 138.

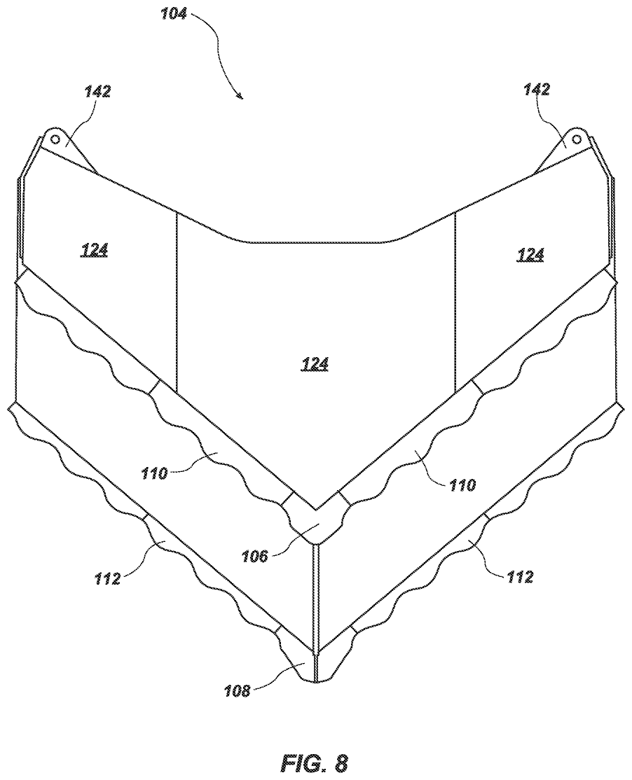

FIG. 8 is an aerial top-down view of the tree felling blade 104. In the embodiment illustrated in FIG. 8, the lower cutter point 108 represent the forward-most point of the tree felling blade 104 and the upper cutter point 106 is located behind the lower cutter point 108, relative to the front of the dozer 102. The debris shield 124 illustrated in FIG. 8 includes three portions each sloping away from the center-point of the tree felling blade 104 to encourage trees and other debris to slide out and away from the dozer 102 pathway.

The tree felling blade 104 further includes fastener components 142 to enable the tree felling blade 104 to be secured to a dozer 102. The fastener components 142 may extend outward relative to the tree felling blade 104 and provide a pin hole or other means for securing the tree felling blade 104 to the dozer 102. The fastener components 142 may be any suitable fastener components and may be selected and specialized based on the dozer 102 selected for use with the tree felling blade 104. The tree feeling blade 104 may be dozer-specific such that the size, weight, fastener configurations, and positions of fasteners are all specialized to a certain dozer model. This enables the tree felling blade 104 to be manufactured separate from the dozer 102 and retrofitted on an existing dozer 102.

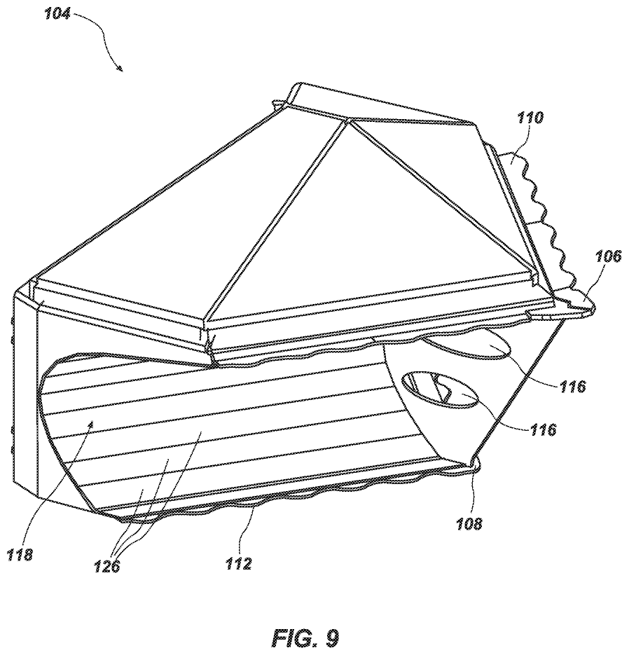

FIG. 9 is an isometric view of the tree felling blade 104. The embodiment illustrated in FIG. 9 particularly depicts the concave curvature of the roller portion 118. In an embodiment, the size and shape of the roller portion is particularly configured to receive tree trunks and tree root balls, and then push those tree trunks and tree root balls outward and away from the dozer 102. The size and shape of the roller portion 118 may vary depending on the intended use-case of the tree felling blade 104 and the sizes of the trees to be removed with the tree felling equipment 100.

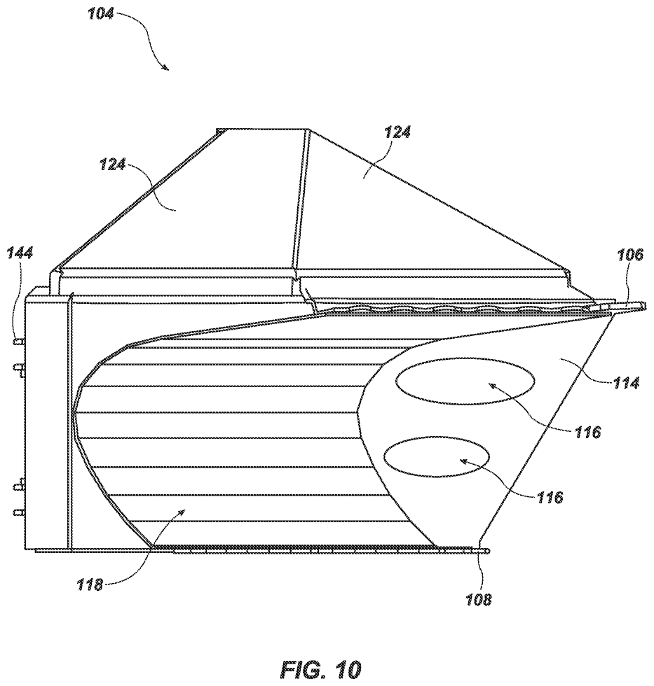

FIG. 10 is a side view of the tree felling blade 104. The tree felling blade 104 includes one or more dozer fastener pins 144 for securing the tree felling blade 104 to the dozer. The fastener pins 144 extend outward from the tree felling blade 104 and may be configured for insertion into corresponding pin holes on the dozer 102. The tree feeling blade 104 may be dozer-specific such that the size, weight, fastener configurations, and positions of fasteners are all specialized to a certain dozer model. This enables the tree felling blade 104 to be manufactured separate from the dozer 102 and retrofitted on an existing dozer 102.

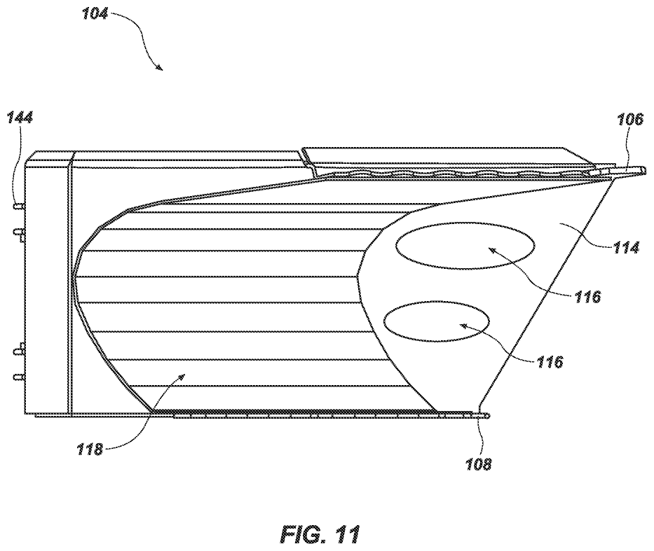

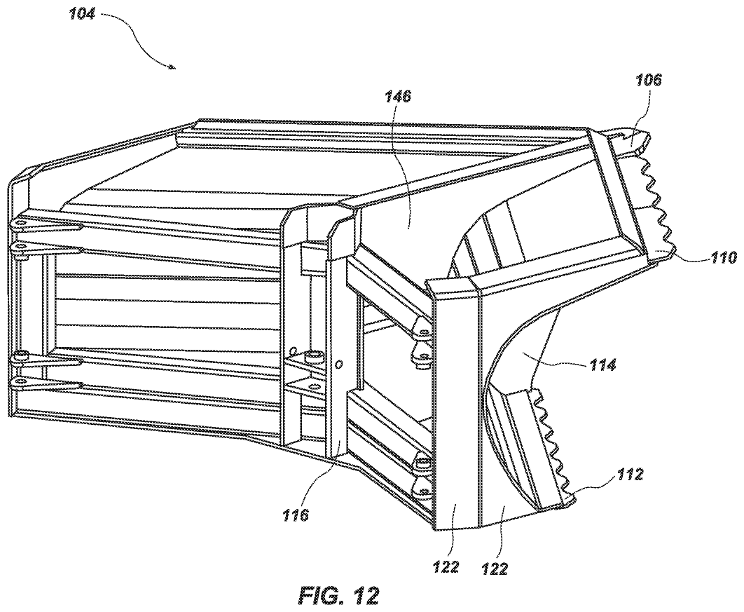

FIG. 11 is a side view of the tree felling blade 104 with the debris shield 124 removed such that the curvature of the roller portion 118 is more easily visible. FIG. 12 is an isometric rear view of the tree felling blade 104 with the debris shield 124 removed such that the interior structure of the tree felling blade 104 is visible. The interior of the tree felling blade 104 includes a support beam 146. The support beam 146 may be shaped with the same concave curvature of the roller portion 118. The leading blade 114 may be attached to the support beam 146 or may be part of the support beam 146 such that the support beam 146 and the leading blade 114 are a singular continuous structure, and the ribbed surfaces 126 are attached thereto.

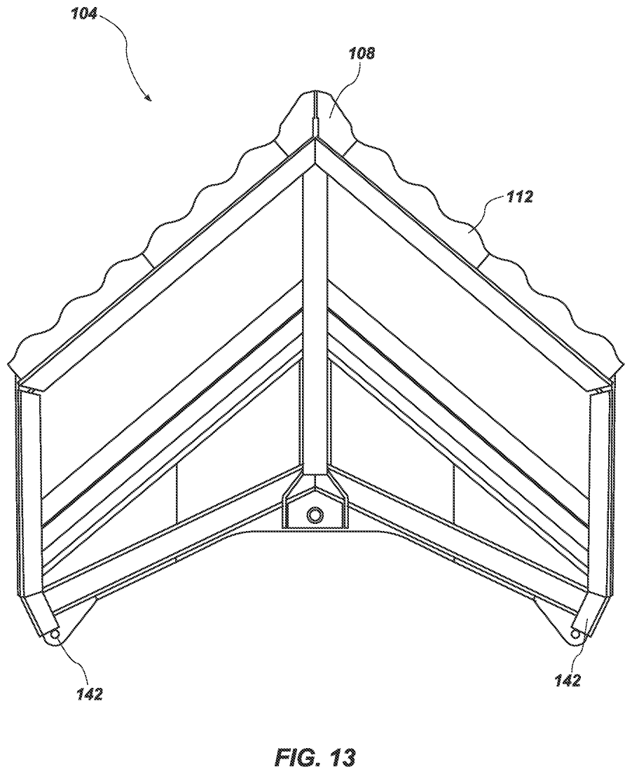

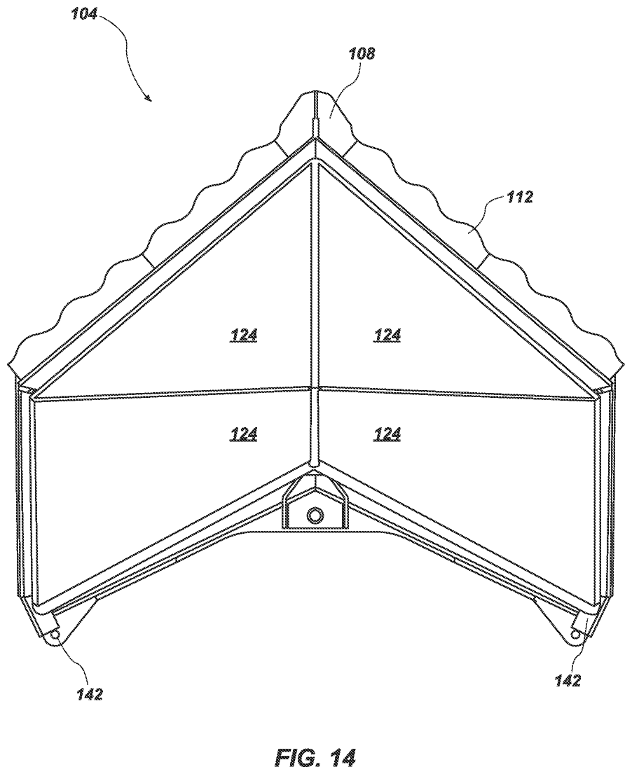

FIG. 13 is an aerial view of the tree felling blade 104. FIG. 14 is a cross-sectional aerial view of the tree felling blade 104.

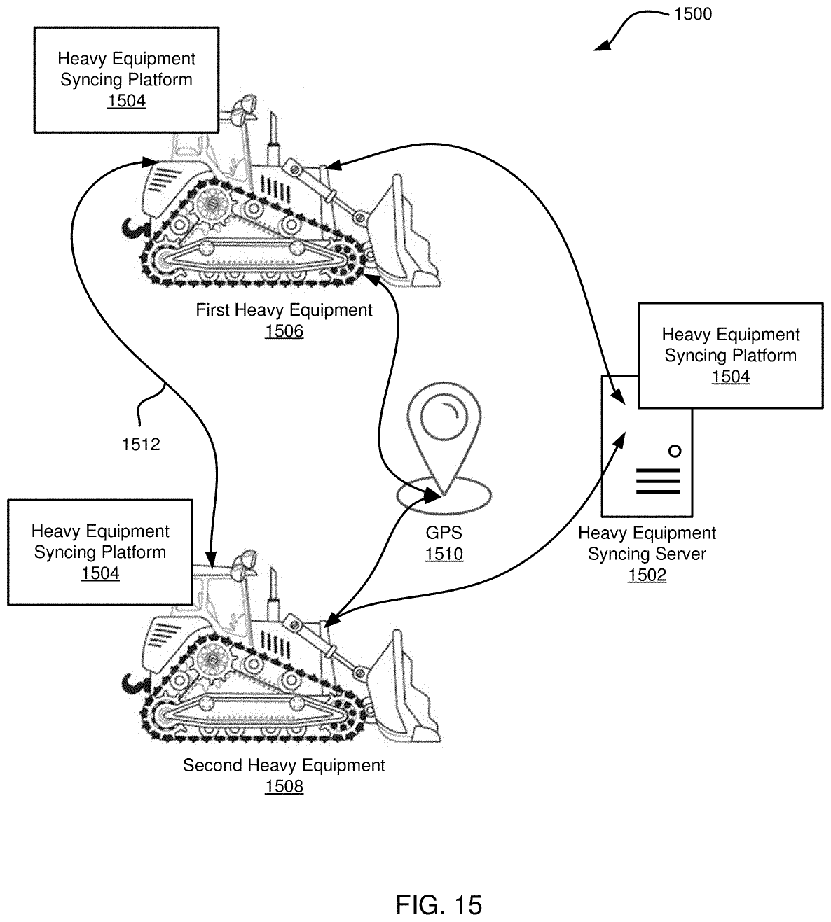

FIG. 15 is a schematic diagram of a system 1500 for inter-machine communications. In the exemplary embodiment illustrated in FIG. 15, the system 1500 provides for communications between a first heavy equipment 1506 and a second heavy equipment 1508. As discussed herein, the first heavy equipment 1506 and the second heavy equipment 1508 may alternatively be referred to as a dozer, bulldozer, or other machinery. It should be appreciated that the system 1500 may provide for communication between a single heavy equipment machine and a server, or between three or more heavy equipment machines. The embodiment illustrated in FIG. 15 should not be seen as limiting.

The system provides for communication 1512 between the first heavy equipment 1506 and the second heavy equipment 1508, and additionally provides for communications between heavy equipment and a Global Positioning System (GPS) 1510 and a heavy equipment syncing server 1502. The heavy equipment server 1502 may provide processing operations for a heavy equipment syncing platform 1504. The heavy equipment syncing platform 1504 may be accessible to one or more users by way of a user interface.

In some implementations, it is important to provide for real-time communications between heavy machinery. Specifically, in tree felling operations, it can be important to provide for real-time communications between two or more dozers. During a tree felling operation, the dozer operators, and the dozer sensor systems, are unable to see one another because there are too many trees and other obstacles between the dozers. In such an operation, it is important to enable real-time communications between the two dozers for the safety of the dozer operators. In an embodiment, each of the first heavy equipment 1506 and the second heavy equipment 1508 is a dozer configured for cutting trees in a tree felling operation. In such an embodiment, each of the first heavy equipment 1506 and the second heavy equipment 1508 may be outfitted with a specialized blade for cutting trees and other objects. It should be appreciated that the disclosures herein are not limited to dozers or tree felling operations, and the first and second heavy equipment 1506, 1508 may represent any heavy equipment or heavy machinery.

The heavy equipment 1506, 1508 may communicate with a GPS 1510. In an embodiment, there is a GPS installed in each of the heavy equipment 1506, 1508, and the installed GPS is capable of communicating with a satellite (or other location) system for determining the precise global coordinates of the heavy equipment 1506, 1508. The GPS 1510 may be a high-precision positioning system to determine the precise global coordinates of the heavy equipment 1506, 1508 at any time. In an embodiment, the heavy equipment 1506, 1508 receives GPS satellite information used with real-time kinematic (RTK) corrections and/or differential GPS (DGPS) corrections. The GPS satellite information with RTK corrections provides for centimeter-level global coordinate accuracy. The GPS satellite information with DGPS corrections provides for sub-meter accuracy. In an embodiment, the RTK corrected GPS satellite information is communicated to the heavy equipment 1506, 1508 to allow for centimeter-level positional accuracy.

In an embodiment, the global coordinates of the heavy equipment 1506, 1508 are continually retrieved and timestamped as the heavy equipment 1506, 1508 is moving or performing an operation. A log of global coordinates, with the accompanying timestamps, may be stored locally on the heavy equipment 1506, 1508, may be communicated 1512 between heavy equipment 1506, 1508, and/or may be uploaded to the heavy equipment syncing server 1502. This timestamped log of global coordinates can be assessed to calculate a precise path of the heavy equipment 1506, 1508 when the heavy equipment 1506, 1508 was moving or performing an operation. In an embodiment, the timestamped log of global coordinates indicates a precise tree felling path that was completed or is currently in-process by the heavy equipment 1506, 1508.

The heavy equipment 1506, 1508 may be in communication with a heavy equipment syncing server 1502. In an embodiment, there is two-way communication between the heavy equipment 1506, 1508 and the heavy equipment syncing server 1502. These communications may be carried out by way of a communications satellite that relays and/or amplifies telecommunications signals between the heavy equipment 1506, 1508 and the heavy equipment syncing server 1502. In an embodiment, the heavy equipment 1506, 1508 communicates with Iridium satellites to upload operations data to the heavy equipment syncing server 1502 for remote operations analytics. This may be particularly beneficial when the heavy equipment 1506, 1508 is located in a remote location with cellular data service. In an embodiment, the heavy equipment 1506, 1508 communicates with the heavy equipment syncing server 1502 by way of cellular data service, such as long-term evolution (LTE) communications. The LTE communications may be 2G, 3G, 4G, 5G, and so forth communications. It should be appreciated that the communications between the heavy equipment 1506, 1508 and the heavy equipment syncing server 1502 may be carried about by any suitable communications technology.

The heavy equipment syncing server 1502 provides processing operations for a heavy equipment syncing platform 1504. The heavy equipment syncing platform 1504 may be provided to a user in a user interface that is accessible on a personal computing device such as a personal computer, a laptop, a mobile phone, and so forth. The heavy equipment syncing platform 1504 may be presented in an application that provides downloadable software for a personal computing device and/or on the Internet by way of a web browser. The heavy equipment syncing platform 1504 may be available as a Software as a Solution (SaaS) solution for managing the heavy equipment 1506, 1508 operations, managing data captured by sensors on the heavy equipment 1506, 1508, managing projects, and so forth.

In an embodiment, the heavy equipment 1506, 1508 communicate 1512 directly with one another. In an embodiment, these communications are accomplished by Bluetooth technology. Bluetooth is a wireless technology standard used for exchanging data between fixed and/or mobile devices over short distances using short-wavelength ultra-high frequency (UHF) radio waves. In a particular embodiment, the Bluetooth communications are carried out in the radio bands from 2.400 to 2.485 GHz. In an embodiment, the communications 1512 between the heavy equipment 1506, 1508 are carried about via long-range radio signals. In a particular embodiment, the long-range radio signals are carried out in radio frequency bands from 775 MHz to 945 MHz. In a more particular embodiment, the long-range radio signals are carried out in radio frequency bands of 863-870 MHz (for Europe), 1502-928 MHz (for Australia and North America), 779-787 MHz (for China), and 1500-930 MHz (for other Asian countries and areas). In an even more particular embodiment, the long-range radio signals are carried out in a radio frequency of 868 MHz (for Europe), 915 MHz (for Australia and North America), 780 MHz (for China), and 923 MHz (for other Asian countries and areas). These communications 1512 provide vital equipment telemetry between the first heavy equipment 1506 and the second heavy equipment 1508.

In an exemplary implementation, the first heavy equipment 1506 carries out a tree felling operation to cut down trees in a first tree felling track the width of the first heavy equipment 1506 blade. During the tree felling operation, the first heavy equipment 1506 captures sensor data to determine, for example, the precise coordinates of the first heavy equipment 1506 at all times during the tree felling operation, the accelerometer data, gyro meter data, and magnetometer data captured by the first heavy equipment 1506 during the tree felling operation, and so forth. This information may be analyzed to calculate a precise path taken by the first heavy equipment 1506 and thereby determine the precise location, width, elevation change, and so forth of the first tree felling track that was cut by the first heavy equipment 1506. This information may be communicated 1512 to the second heavy equipment 1508 such that the second heavy equipment 1508 can then cut a second tree felling track that is exactly or nearly parallel to the first tree felling track at all times. The first tree felling track and the second tree felling track may be located a set difference apart from one another at all times, for example 250 feet apart from one another, and the two tracks may be exactly parallel. The sensor data captured by the first heavy equipment 1506 is communicated 1512 to the second heavy equipment 1508 to make it possible for the second heavy equipment 1508 to cut the second tree felling track exactly parallel to the first tree felling track. Without this communication 1512, the two tracks would not be exactly parallel and would likely deviate from one another. It is important for the two tracks to be parallel to ensure the safety of the operators in future tree felling operations, as detailed further below.

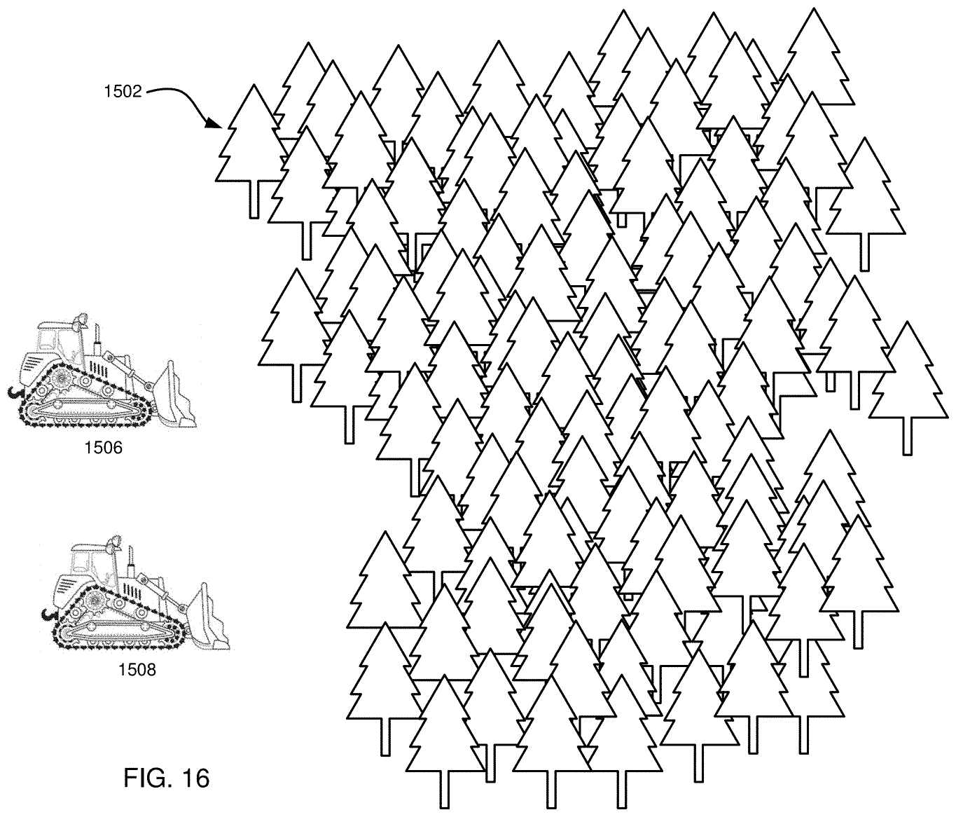

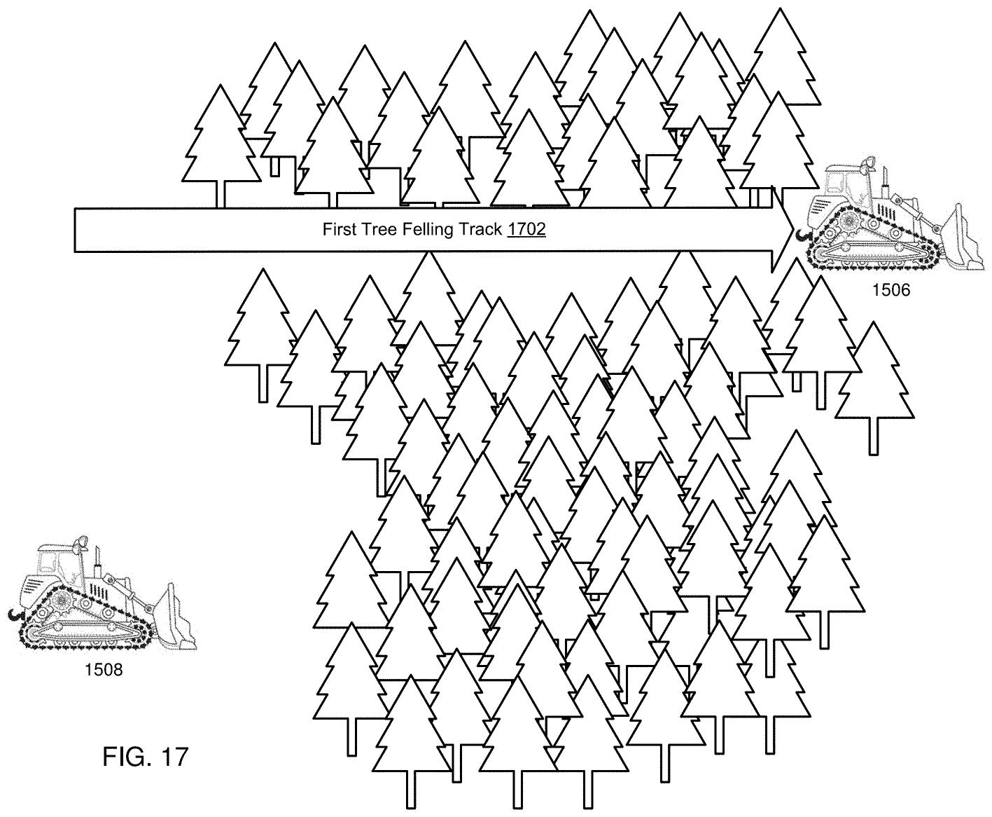

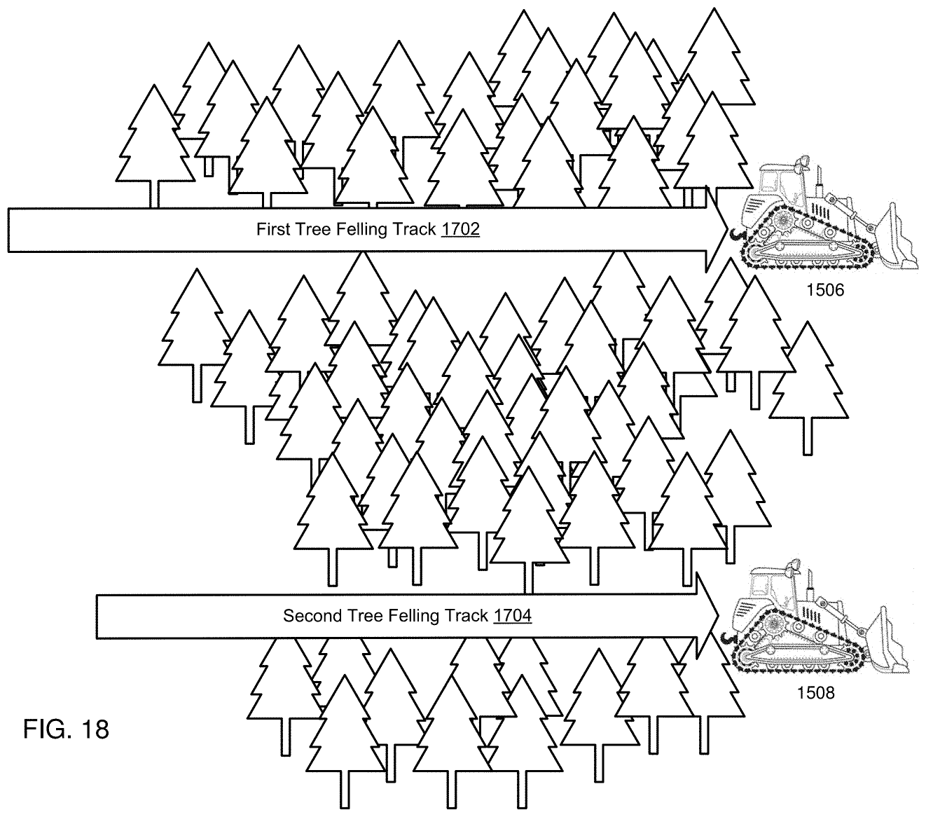

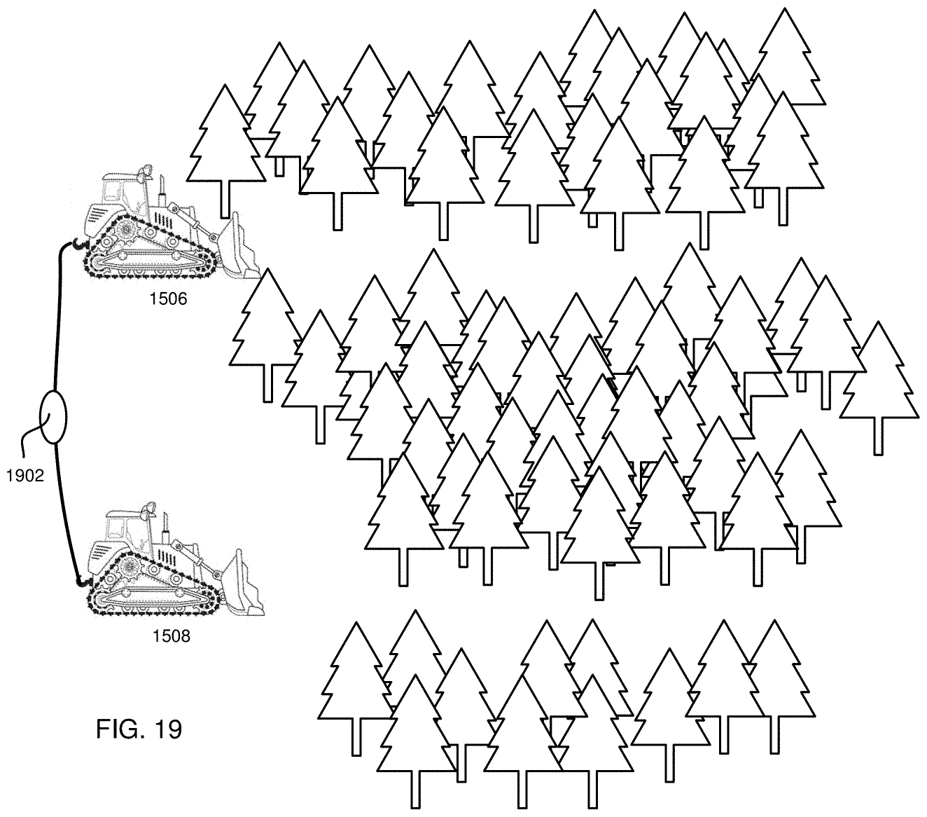

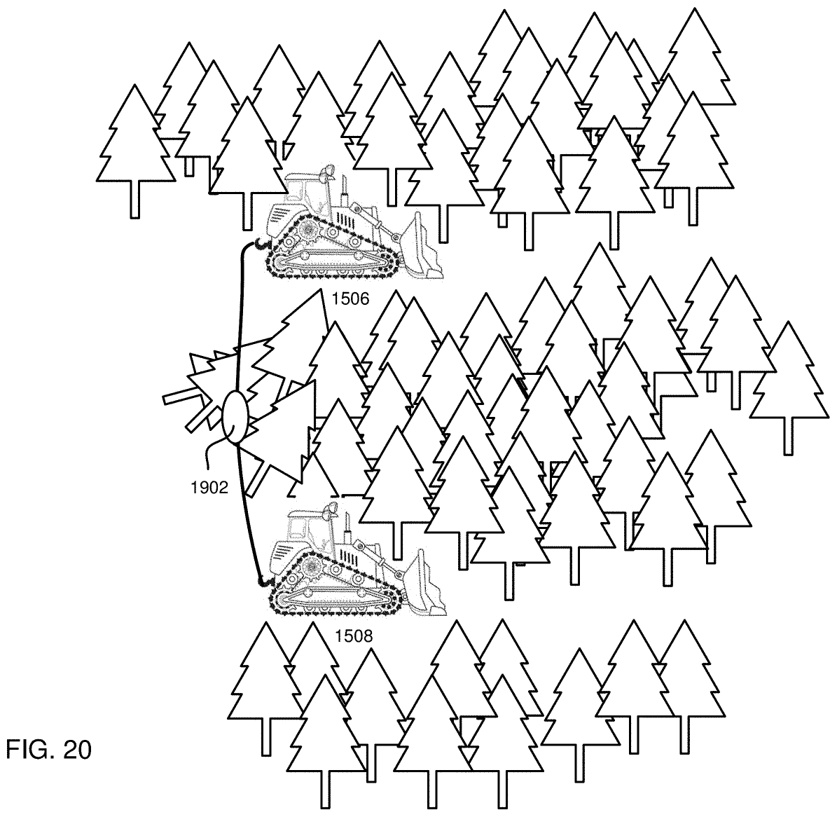

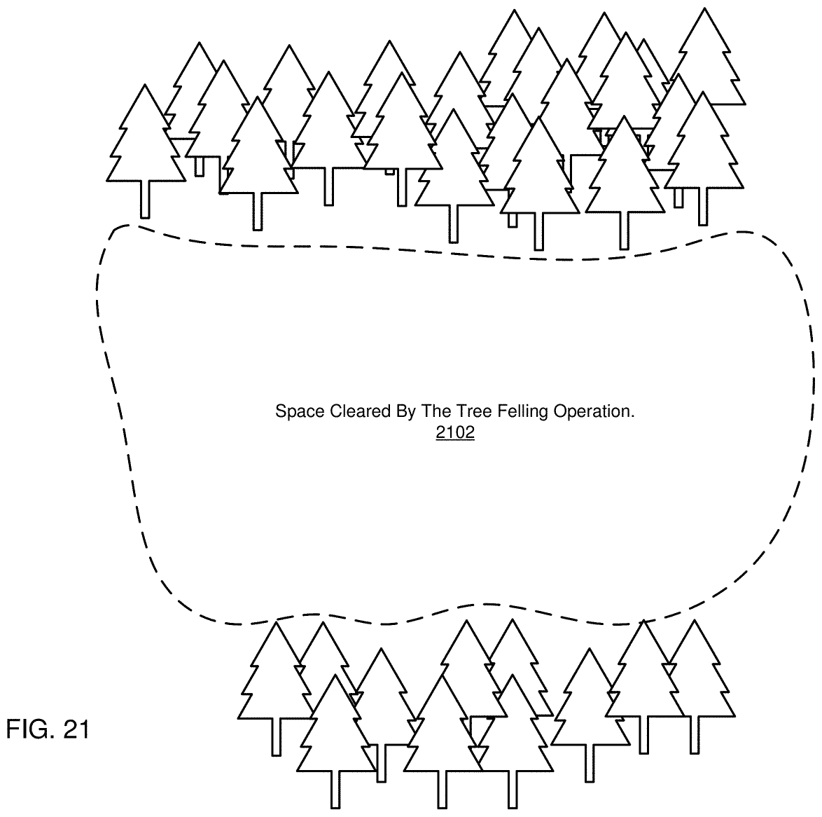

FIGS. 16-21 illustrate exemplary implementations and use-cases of the disclosures presented herein. FIG. 16 illustrates two heavy equipment machines in preparation to perform a tree felling operation of a tree grouping 1502. FIG. 17 illustrates a first phase of an exemplary tree felling operation. FIG. 18 illustrates a second phase of an exemplary tree felling operation. FIGS. 19-20 illustrate a third phase of an exemplary tree felling operation. FIG. 21 illustrates an alternative implementation of a tree felling operation.

FIG. 16 illustrates the first heavy equipment 1506 and the second heavy equipment 1508 stationed in preparation to perform a tree felling operation on the tree grouping 1502. In some instances, it is beneficial to perform tree felling operations in preparation for a potential forest fire or to curtail the progression of an active forest fire. This type of tree felling operation is typically performed to create a gap within the tree grouping 1502 such that the fire cannot easily hop from tree to tree and burn through the entire tree grouping. When the tree felling operation is performed on the tree grouping 1502, then a fire may be halted at the edge of the gap because the fire cannot move to the trees on the opposite end of the gap.

FIG. 17 illustrates a first phase of an exemplary tree felling operation. The first heavy equipment 1506 cuts the first tree felling track 1702 through the tree grouping. Depending on the landscape of the tree grouping, the first tree felling track 1702 might not be a straight line and may traverse changes in elevation. For purposes of illustrate, the first tree felling track 1702 illustrated in FIG. 17 is shown as a straight line, but it should be appreciated that a tree felling track is typically not a straight line in typical real-world implementations.

The first heavy equipment 1506 includes numerous sensors for tracking the operation of cutting the first tree felling track 1702. The first heavy equipment 1506 may include, for example, a GPS receiver, an accelerometer, a gyro meter, a magnetometer, a winch sensor, and so forth. The first heavy equipment 1506 collects sensor data while it traverses the first tree felling track 1702 and determines precise location coordinates for the length of the first tree felling track 1702.

In an embodiment, the first heavy equipment 1506 includes a computing system having one or more processors for executing instructions stored in non-transitory computer readable storage media. The instructions may include receiving location coordinate data from the GPS 1510 and may further include receiving timestamped location coordinate data from the GPS 1510 for the duration of the time the first heavy equipment 1506 is cutting the first tree felling track 1702. The instructions may further include receiving sensor data from one or more sensors on the first heavy equipment 1506, including for example, accelerometer sensor data, gyro meter sensor data, magnetometer sensor data, winch release sensor data, and so forth. The instructions may further include merging one or more forms of sensor data to generate merged data. The instructions may further include assessing the sensor data and/or the location coordinate data to calculate a precise path of the first tree felling track 1702 including GPS location coordinates for the first tree felling track 1702. The precise path of the first tree felling track 1702 may further include information about elevation changes or tilting of the first heavy equipment 1506 for the duration of the tree felling operation. The first heavy equipment 1506 stores the path for the first tree felling track 1702. In an embodiment, the first heavy equipment 1506 transmits the path for the first tree felling track 1702 to the second heavy equipment 1508 by way of long-range radio waves, Bluetooth communication, or some other communication technology.

FIG. 18 illustrates a second phase of the exemplary tree felling operation. The second phase of the tree felling operation includes cutting a second tree felling track 1704 that runs parallel to the first tree felling track 1702. If the first tree felling track 1702 includes turns, curves, or changes in direction, then the second tree felling track 1702 will include the same turns, curves, and changes in direction to ensure the first tree felling track 1702 and the second tree felling track 1704 are parallel. The second tree felling track 1704 is located a set distance away from the first tree felling track 1702 depending on the end-goals of the tree felling operation. In an example implementation, the first tree felling track 1702 and the second tree felling track 1704 are between 1500 feet to 500 feet away from one another. It should be appreciated that the distance between the first tree felling track 1702 and the second tree felling track 1704 is implementation-specific and that any suitable distance falls within the disclosures herein.

It should be appreciated that the second phase of the tree felling operation may be performed by the same heavy equipment that executed the first phase of the tree felling operation. When the first phase and the second phase are performed by the same heavy equipment, then the path of the first tree felling track 1702 may be stored locally at the same heavy equipment and then referred to when cutting the path of the second tree felling track 1704.

In an embodiment, the second phase of the tree felling operation is performed by a different heavy equipment machine when compared with the first phase of the tree felling operation. In such an embodiment, the first heavy equipment 1506 cuts the first tree felling track 1702 and determines the path of the first tree felling track based on sensor data generated when the first heavy equipment 1506 cut the first tree felling track 1702. The path of the first tree felling track 1702 is an electronic file (may be referred to herein as the first tree felling track file) including precise location coordinates for the first tree felling track 1702 along with additional valuable sensor data, such as an indication of changes in elevation or tilting experienced by the first heavy equipment 1506. The first heavy equipment 1506 sends the path of the first tree felling track to the second heavy equipment 1508.

The second heavy equipment 1508 receives the path of the first tree felling track from the first heavy equipment 1506 by way of a communication 1512. The second heavy equipment 1508 then cuts the second tree felling track 1704 parallel to the first tree felling track 1702. In an embodiment, a user may manually input a desired distance between the first tree felling track 1702 and the second tree felling track 1704 or the desired distance may be calculated based on environmental data, saved operational files, and so forth. The second heavy equipment 1508 then cuts the second tree felling track 1704 to be parallel to the first tree felling track 1702 with the help of the heavy equipment syncing platform 1504. In an embodiment, the second heavy equipment 1508 is automated to execute cutting the second tree felling track 1704 without human intervention and with the assistance of the heavy equipment syncing platform 1504. In an embodiment, an operation of the second heavy equipment 1508 cuts the second tree felling track 1704 with the assistance of the heavy equipment syncing platform 1504.

In an embodiment, the heavy equipment syncing platform 1504 provides directional information to a controller for the second heavy equipment 1508 such that the second heavy equipment 1508 can automatically cut the second tree felling track 1704 without human intervention. In an embodiment, the heavy equipment syncing platform 1504 provides messages, notifications, and information on a dashboard to an operator of the second heavy equipment 1508 such that the operator can control the second heavy equipment 1508 and cut the second tree felling track 1704 parallel to the first tree felling track 1702.

In an embodiment, while the second heavy equipment 1508 is cutting the second tree felling track 1704 (either automatically or with a human operator), the heavy equipment syncing platform 1504 provides detailed instructions on how to cut the second tree felling track 1704 to be parallel with the first tree felling track 1702. For example, the heavy equipment syncing platform 1504 may provide a code-based instruction, a text-based readable instructions, and/or a verbalized instruction that the second heavy equipment 1508 needs to turn a number of degrees to the left or the right to remain parallel with the first tree felling track 1702. Further for example, the heavy equipment syncing platform 1504 may provide warnings about anticipated changes in elevation, tilts to the landscape, hard turns, and so forth. The heavy equipment syncing platform 1504 provides necessary information and guidance to the second heavy equipment 1508 (either a controller of the equipment itself or a human operator) such that the second tree felling track 1704 remains parallel to the first tree felling track 1702.

FIGS. 19-20 illustrate a third phase of the exemplary tree felling operation. At the start of the third phase, each of the first tree felling track 1702 and the second tree felling track 1704 has been successfully cut down. The trees within these tracks additionally may be removed from the site. The first heavy equipment 1506 and the second heavy equipment 1508 may return to the “starting line” of the respective tracks or may begin at the “finish line” of the respective tracks and traverse the tracks backwards. During the third phase, the first heavy equipment 1506 and the second heavy equipment 1508 are connected to one another with a cable, chain, or other heavy-duty rope-like connection (may be referred to herein as a “cable” to generically refer to any of the above). In an embodiment, in the middle of the cable is a roller 1902 that may consist of a large weight with an elliptical, spherical, or football-like shape. The roller 1902 may be large and very heavy such that the roller 1902 can roll along the ground and knock over, uproot, and/or crush trees within its path. In an embodiment, each heavy equipment 1506, 1508 has a separate cable extending from a winch that is attached to the connection rod 106 of the roller 1902.

In existing implementations, the roller 1902 is not attached to the cable but is instead free such that it can roll on its own. In such an implementation, the cable may be used to pull or drag the roller 1902 in the desired direction. Specifically, in this implementation, the roller 1902 may pose a serious danger to the operators of the heavy equipment 1506, 1508 if the trajectory or speed of the roller 1902 are not continually controlled. For example, if the heavy equipment 1506, 1508 and the roller 1902 are travelling downhill, the roller 1902 may gather speed and begin to roll in undesirable directions. For this reason, it can be imperative that the trajectory and speed of the roller are controlled by the first heavy equipment 1506 and the second heavy equipment 1508. This can most effectively be accomplished by ensuring the roller 1902 is located at the midpoint between the heavy equipment 1506, 1508, ensuring the cable between the heavy equipment 1506, 1508 is taught, and ensuring the heavy equipment 1506, 1508 are in line with one another such that one heavy equipment is not in front of or lagging behind the other. Each of these considerations is accomplished by way of the communications 1512 between the first heavy equipment 1506 and the second heavy equipment 1508, along with the information provided by the heavy equipment syncing platform 1504.

During the third phase, the first heavy equipment 1506 and the second heavy equipment 1508 are continually in communication with one another by way of some form of communication 1512. In an embodiment, the heavy equipment 1506, 1508 communicate real-time location coordinates and sensor data to one another continually throughout execution of the third phase. This can be especially important when there is a roller 1902 attached to the cable. The roller may be extremely heavy and large such that it poses a significant danger to the operators of the heavy equipment 1506, 1508 and the heavy equipment itself if the trajectory of the roller 1902 is not properly controlled. For this reason, it is important to control the location and speed of the roller 1902 throughout execution of the third phase. This may be most effectively accomplished by ensuring the roller 1902 remains in the middle point between the first heavy equipment 1506 and the second heavy equipment 1508 and ensuring that the first heavy equipment 1506 and the second heavy equipment 1508 are lined up such that one is not in front of or lagging behind the other.

During the third phase, the first heavy equipment 1506 and the second heavy equipment 1508 continually communicate 1512 real-time location coordinates and sensor data to one another. The communications 1512 between the heavy equipment 1506, 1508 may occur five times per second in one exemplary embodiment. Each of the heavy equipment 1506, 1508 may include a system including one or more processors for analyzing the location coordinates and sensor data and presenting this information to an operator by way of the heavy equipment syncing platform 1504. Additionally, the information presented in the heavy equipment syncing platform 1504 may be received from the heavy equipment syncing server 1502 by way of a cellular network connection or a satellite communication connection. In an embodiment, each of the heavy equipment 1506, 1508 includes a screen for displaying the heavy equipment syncing platform 1504 and providing operational messages to an operator of the heavy equipment 1506, 1508.

In an embodiment, one or more on-board processors of the heavy equipment 1506, 1508 receive communications 1512 from the other heavy equipment and receive sensor data from the instant heavy equipment 1506, 1508. The one or more on-board processors analyze the sensor data captured by its own sensors and the sensor data captured by the other heavy equipment 1506, 1508. Based on this analysis, the on-board processors determine whether the instant heavy equipment 1506, 1508 should turn, slow down, speed up, remain on the present course, or change course to ensure that the two heavy equipment 1506, 1508 are in line with one another, that the slack of the cable is sufficiently taught, and that the roller 1902 remains at the midpoint between the heavy equipment 1506, 1508. The onboard processors may generate a message to be displayed or verbalized to an operator of the heavy equipment 1506, 1508 and/or electronically transmitted to an electronic controller, driver assistance system, or automated driving system of the heavy equipment 1506, 1508. The message may indicate for example, that the two heavy equipment 1506, 1508 are no longer in-line and that the instant heavy equipment should slow down or speed up. The message may indicate that the slack on the cable is not sufficiently taught or is excessively taught, and that the winch should be wound to pull in more cable or release more cable. The message may indicate, for example, that the heavy equipment 1506, 1508 should make a turn a certain degree to the left or the right. The message may indicate, for example, that the heavy equipment 1506, 1508 are in line with one another and that the operation is proceeding as planned. Such a message may indicate that no changes in speed, direction, cable slack, or other parameters need to be adjusted at the present time.

In an embodiment, the instructions for changing a parameter or maintain the current course may be received from the heavy equipment syncing server by way of a cellular network connection or a satellite communication connection. These instructions might be provided in real time based on output from a neural network trained to analyze satellite imagery of forests and/or the sensor data generated by the heavy equipment 1506, 1508. These instructions might be manually input be a user interacting with the heavy equipment syncing platform 1504 in communication with the heavy equipment syncing server 1502. For example, a forest fire manager or wildlife service contractor may be provided instructions via the heavy equipment syncing platform 1504 indicating that the heavy equipment 1506, 1508 should change course, alter the original tree felling plan, engage in a new tree felling plan, continue the present course, evacuate the area, and so forth. In an embodiment, an emergency evacuation message is transmitted to the heavy equipment 1506, 1508, and the emergency evacuation message is transmitted from the heavy equipment syncing server 1502.

FIG. 20 illustrates a continuation of the third phase of the exemplary tree felling operation that is illustrated in FIG. 19. In FIG. 20, the heavy equipment 1506, 1508 are travelling along the first tree felling track 1702 and the second tree felling track 1704 in line with one another while pulling the roller 1902 along the area located between the first tree felling track 1702 and the second tree felling track 1704. The cable and the roller 1902 may be configured to break, pull, and/or drag the trees located in the space between the first tree felling track 1702 and the second tree felling track 1704. At the end of the third phase, the heavy equipment 1506, 1508 will have traversed the entire tree felling tracks and cleared the space located between the tree felling tracks.

FIG. 21 illustrates a space that has been successfully cleared. The dotted line illustrates the space 2102 created by way of the tree felling operation. The space 2102 includes the first tree felling track 1702, the second tree felling track 1704, and the space between the first and second tree felling tracks 1702, 1704. This space may serve to prevent the spread of forest fires. For example, if a fire is burning at the upper portion of the trees, the fire might not successfully transfer to the lower portion of trees because the space 2102 is sufficiently large to prevent sparks from travelling to the lower portion of trees (and vice versa).

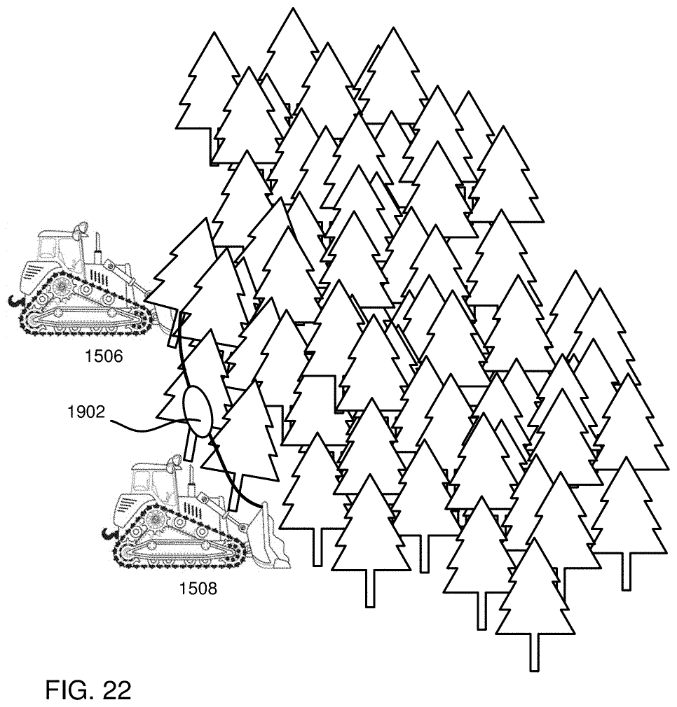

FIG. 22 illustrates an alternative tree felling operation. In the alternative tree felling operation, the first heavy equipment 1506 and the second heavy equipment 1508 are connected to one another by way of one or more cables and the roller 1902. In this alternative operation, the heavy equipment 1506, 1508 pull the roller 1902 through the tree grouping without first cutting a tree felling track. Again, in this implementation, the heavy equipment 1506, 1508 may communicate 1512 with one another in real-time to ensure the cable has sufficient slack, the heavy equipment 1506, 1508 are traversing the correct path, and the roller 1902 is safely located between the heavy equipment 1506, 1508. Notably, while performing a tree felling operation, the operators of the heavy equipment 1506, 1508 likely will not be able to see one another, and therefore it is imperative that the operators can receive guidance and communications from the heavy equipment syncing platform 1504 to ensure the safety of the operators and the equipment 1506, 1508 itself.

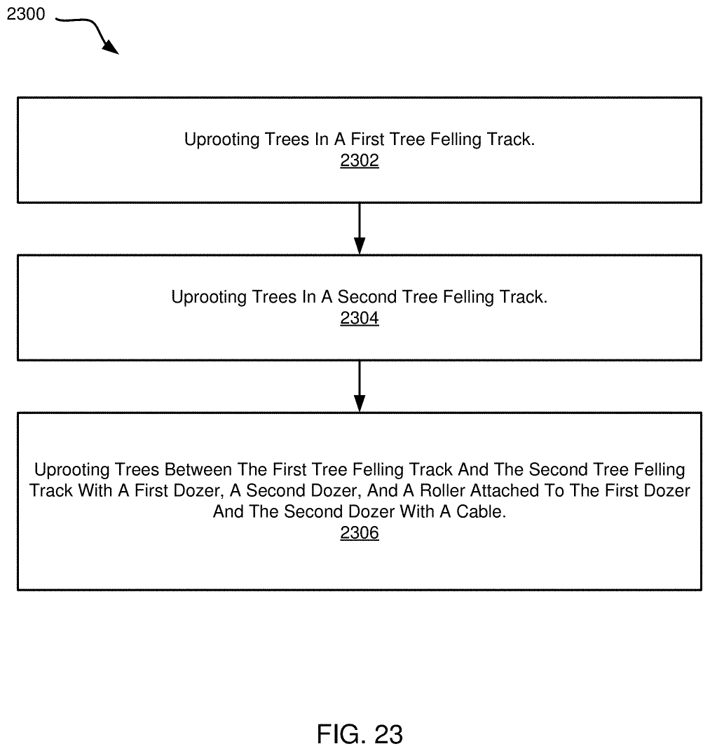

FIG. 23 is a schematic flow chart diagram of a method 2300 for executing a tree felling operation. The method 2300 begins and a dozer uproots at 2302 trees in a first tree felling track. The method 2300 continues and a dozer uproots at 2304 trees in a second tree felling track. The method 2300 continues and a first dozer and a second dozer uproot trees between the first tree felling track and the second tree felling track at 2306. There is a roller attached to the first dozer and the second dozer by way of one or more cables.

### Examples

The following examples pertain to further embodiments.

Example 1 is an apparatus. The apparatus includes a leading cutter comprising a leading cutter point and a leading transverse cutting blade. The apparatus includes a trailing cutter comprising a trailing cutter point and a trailing transverse cutting blade. The apparatus includes a roller portion comprising a concave curvature, wherein the roller portion is connected to the leading cutter and the trailing cutter.

Example 2 is an apparatus as in Example 1, wherein the apparatus is configured to be attached to a front side of heavy equipment, and wherein the leading cutter point is the forward-most point of the apparatus relative to the front side of the heavy equipment.

Example 3 is an apparatus as in any of Examples 1-2, wherein: the leading cutter comprises a serrated or scalloped edge configured for gripping a tree trunk during operation; and the trailing cutter comprises a serrated or scalloped edge configured for gripping a root ball during operation.

Example 4 is an apparatus as in any of Examples 1-3, further comprising a leading blade, wherein the leading blade is attached to the leading cutter point on one end and the trailing cutter point on an opposite end, and wherein the leading blade in normal or approximately normal to a plane of the leading transverse cutting blade and a plane of the trailing transverse cutting blade.

Example 5 is an apparatus as in any of Examples 1-4, wherein the leading blade comprises a flat surface comprising a hole disposed therethrough.

Example 6 is an apparatus as in any of Examples 1-5, wherein the apparatus is configured to be secured to a dozer, and wherein the apparatus further comprises a debris shield comprising a plurality of sloped slides configured to cause debris to deflect away from the dozer.

Example 7 is an apparatus as in any of Examples 1-6, further comprising an adaptor for removably fastening the apparatus to a dozer.

Example 8 is an apparatus as in any of Examples 1-7, further comprising a frame comprising one or more side portions, and wherein: the leading transverse cutting blade is attached to the leading cutter point on a first end and one of the one or more side portions on an opposite end; and the trailing transverse cutting blade is attached to the trailing cutter point on a first end and one of the one or more side portions on an opposite end.

Example 9 is an apparatus as in any of Examples 1-8, wherein: the leading transverse cutting blade comprises two leading transverse cutting blades with equivalent dimensions, wherein each of the two leading transverse cutting blades is attached to the leading cutter point; and the trailing transverse cutting blade comprises two trailing transverse cutting blades with equivalent dimensions, wherein each of the two trailing transverse cutting blades is attached to the trailing cutter point.

Example 10 is an apparatus as in any of Examples 1-9, wherein: the leading cutter is the forward-most point of the apparatus during operation; and the leading cutter is located above the trailing cutter relative to the ground.

Example 11 is a system for executing a tree felling operation. The system includes a dozer and an apparatus attached to the dozer. The apparatus includes a leading cutter comprising a leading cutter point and a leading transverse cutting blade. The apparatus includes a trailing cutter comprising a trailing cutter point and a trailing transverse cutting blade. The apparatus includes a roller portion comprising a concave curvature, wherein the roller portion is connected to the leading cutter and the trailing cutter.

Example 12 is a system as in Example 11, wherein the apparatus is such that the leading cutter point is the forward-most point of the apparatus relative to a front side of the dozer.

Example 13 is a system as in any of Examples 11-12, wherein the apparatus is such that: the leading cutter comprises a serrated or scalloped edge configured for gripping a tree trunk during operation; and the trailing cutter comprises a serrated or scalloped edge configured for gripping a root ball during operation.

Example 14 is a system as in any of Examples 11-13, wherein the apparatus further comprises a leading blade, wherein the leading blade is attached to the leading cutter point on one end and the trailing cutter point on an opposite end, and wherein the leading blade in normal or approximately normal to a plane of the leading transverse cutting blade and a plane of the trailing transverse cutting blade.

Example 15 is a system as in any of Examples 11-14, wherein the apparatus is such that the leading blade comprises a flat surface comprising a hole disposed therethrough.

Example 16 is a system as in any of Examples 11-15, wherein the apparatus further comprises a debris shield comprising a plurality of sloped slides configured to cause debris to deflect away from the dozer.

Example 17 is a system as in any of Examples 11-16, wherein the apparatus further comprises a plug-and-play adaptor for removably fastening the apparatus to the dozer.

Example 18 is a system as in any of Examples 11-17, wherein the apparatus further comprises a frame comprises one or more side portions, and wherein the apparatus is such that: the leading transverse cutting blade is attached to the leading cutter point on a first end and one of the one or more side portions on an opposite end; and the trailing transverse cutting blade is attached to the trailing cutter point on a first end and one of the one or more side portions on an opposite end.

Example 19 is a system as in any of Examples 11-18, wherein the apparatus is such that: the leading transverse cutting blade comprises two leading transverse cutting blades with equivalent dimensions, wherein each of the two leading transverse cutting blades is attached to the leading cutter point; and the trailing transverse cutting blade comprises two trailing transverse cutting blades with equivalent dimensions, wherein each of the two trailing transverse cutting blades is attached to the trailing cutter point.

Example 20 is a system as in any of Examples 11-19, wherein the apparatus is such that: the leading cutter is the forward-most point of the apparatus during operation; and the leading cutter is located above the trailing cutter relative to the ground.

Example 21 is a system for executing a tree felling operation. The system includes a dozer and a tree felling blade attached to the dozer. The tree felling blade includes any of the features described in connection with the apparatus of Examples 1-20.

Reference throughout this specification to “an example” means that a particular feature, structure, or characteristic described in connection with the example is included in at least one embodiment of the disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the disclosure may be referred to herein along with alternatives for the various components thereof. It is understood that such embodiments, examples, and alternatives are not to be construed as de facto equivalents of one another but are to be considered as separate and autonomous representations of the disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure.

What is claimed is:

1. An apparatus comprising:
a leading cutter comprising a leading cutter point and a leading transverse cutting blade;
a trailing cutter comprising a trailing cutter point and a trailing transverse cutting blade;
a roller portion comprising a concave curvature, wherein the roller portion is connected to the leading cutter and the trailing cutter.

2. The apparatus of claim 1, wherein the apparatus is configured to be attached to a front side of heavy equipment, and wherein the leading cutter point is the forward-most point of the apparatus relative to the front side of the heavy equipment.

3. The apparatus of claim 1, wherein:
the leading cutter comprises a serrated or scalloped edge configured for gripping a tree trunk during operation; and
the trailing cutter comprises a serrated or scalloped edge configured for gripping a root ball during operation.

4. The apparatus of claim 1, further comprising a leading blade, wherein the leading blade is attached to the leading cutter point on one end and the trailing cutter point on an opposite end, and wherein the leading blade in normal or approximately normal to a plane of the leading transverse cutting blade and a plane of the trailing transverse cutting blade.

5. The apparatus of claim 4, wherein the leading blade comprises a flat surface comprising a hole disposed therethrough.

6. The apparatus of claim 1, wherein the apparatus is configured to be secured to a dozer, and wherein the apparatus further comprises a debris shield comprising a plurality of sloped slides configured to cause debris to deflect away from the dozer.

7. The apparatus of claim 1, further comprising an adaptor for removably fastening the apparatus to a dozer.

8. The apparatus of claim 1, further comprising a frame comprising one or more side portions, and wherein:
the leading transverse cutting blade is attached to the leading cutter point on a first end and one of the one or more side portions on an opposite end; and the trailing transverse cutting blade is attached to the trailing cutter point on a first end and one of the one or more side portions on an opposite end.

9. The apparatus of claim 1, wherein:
the leading transverse cutting blade comprises two leading transverse cutting blades with equivalent dimensions, wherein each of the two leading transverse cutting blades is attached to the leading cutter point; and
the trailing transverse cutting blade comprises two trailing transverse cutting blades with equivalent dimensions, wherein each of the two trailing transverse cutting blades is attached to the trailing cutter point.

10. The apparatus of claim 1, wherein:
the leading cutter is the forward-most point of the apparatus during operation; and
the leading cutter is located above the trailing cutter relative to the ground.

11. A system for executing a tree felling operation, the system comprising:
a dozer; and
an apparatus attached to the dozer, the apparatus comprising:
a leading cutter comprising a leading cutter point and a leading transverse cutting blade;
a trailing cutter comprising a trailing cutter point and a trailing transverse cutting blade; and
a roller portion comprising a concave curvature, wherein the roller portion is connected to the leading cutter and the trailing cutter.

12. The system of claim 11, wherein the apparatus is such that the leading cutter point is the forward-most point of the apparatus relative to a front side of the dozer.

13. The system of claim 11, wherein the apparatus is such that:
the leading cutter comprises a serrated or scalloped edge configured for gripping a tree trunk during operation; and
the trailing cutter comprises a serrated or scalloped edge configured for gripping a root ball during operation.

14. The system of claim 11, wherein the apparatus further comprises a leading blade, wherein the leading blade is attached to the leading cutter point on one end and the trailing cutter point on an opposite end, and wherein the leading blade in normal or approximately normal to a plane of the leading transverse cutting blade and a plane of the trailing transverse cutting blade.

15. The system of claim 14, wherein the apparatus is such that the leading blade comprises a flat surface comprising a hole disposed therethrough.

16. The system of claim 11, wherein the apparatus further comprises a debris shield comprising a plurality of sloped slides configured to cause debris to deflect away from the dozer.

17. The system of claim 11, wherein the apparatus further comprises a plug-and-play adaptor for removably fastening the apparatus to the dozer.

18. The system of claim 11, wherein the apparatus further comprises a frame comprises one or more side portions, and wherein the apparatus is such that:
the leading transverse cutting blade is attached to the leading cutter point on a first end and one of the one or more side portions on an opposite end; and
the trailing transverse cutting blade is attached to the trailing cutter point on a first end and one of the one or more side portions on an opposite end.

19. The system of claim 11, wherein the apparatus is such that:
the leading transverse cutting blade comprises two leading transverse cutting blades with equivalent dimensions, wherein each of the two leading transverse cutting blades is attached to the leading cutter point; and
the trailing transverse cutting blade comprises two trailing transverse cutting blades with equivalent dimensions, wherein each of the two trailing transverse cutting blades is attached to the trailing cutter point.

20. The system of claim 11, wherein the apparatus is such that:
the leading cutter is the forward-most point of the apparatus during operation; and
the leading cutter is located above the trailing cutter relative to the ground.
